(19) United States
(12) Patent Application Publication
(10) Pub. No.: US 2007/0015090 A9
(43) Pub. Date: Jan. 18, 2007

(54) Method of manufacturing a microlens substrate, a microlens substrate, a transmission screen, and a rear projection

(75) Inventor: Nobuo Shimizu, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/369,933

(22) Filed: Mar. 6, 2006

(30) Foreign Application Priority Data
Mar. 10, 2005 (JP) 2005-067863

(51) Int. Cl. G03C 5/00; B29D 11/00

(52) U.S. Cl. 430/321; 430/322; 264/1.38; 264/1.7

(57) ABSTRACT

A method of manufacturing a microlens substrate 1 is disclosed. The microlens substrate 1 is composed of a base substrate 4 having two major surfaces and having light transparency and a lens portion 2 having a plurality of microlenses 21. The lens portion 2 is provided on one of the two major surfaces 24 of the base substrate 4. The method includes the steps of: preparing a substrate with concave portions having two major surfaces, a plurality of concave portions being formed on one of the two major surfaces of the substrate with concave portions; supplying a resin material for forming the lens portion 2 onto the one major surface of the substrate with concave portions on which the plurality of concave portions are formed, the resin material being constituted from a photopolymer having a photocuring property as a main component and containing an additive constituted from at least one of a diffusing agent and a coloring agent, the diffusing agent having a function of diffusing incident light to the resin material; preparing the base substrate 4; mounting the base substrate 4 on the supplied resin material; photocuring the resin material by light to form the lens portion 2 in a state where the base substrate 4 is in contact with the resin material, whereby the base substrate 4 is bonded to the photocured resin material; and removing the substrate with concave portions from the photocured resin material to obtain the microlens substrate 1 provided with the lens portion 2.

### CROSS-REFERENCE TO RELATED APPLICATION

This application claims priority to Japanese Patent Application No. 2005-67863 filed Mar. 10, 2005, which is hereby expressly incorporated by reference herein in its entirety.

### FIELD OF THE INVENTION

The present invention relates to a method of manufacturing a microlens substrate, a microlens substrate, a transmission screen, and a rear projection.

### BACKGROUND OF THE INVENTION

In recent years, demand for a rear projection is becoming increasingly strong as a suitable display for a monitor for a home theater, a large screen television, or the like. In such a rear projection, in order to improve contrast of an image to be projected, it is required to inhibit the reflection of outside light from an emission side (that is, viewer side) of the image light of the rear projection while inhibiting a drop of the intensity of the image light. In order to achieve such an object, a screen (rear projection type screen) in which a microlens substrate (microlens array sheet) provided with a base substrate on the whole surface of which a coloring agent is supplied and a lens portion having a plurality of microlenses on a light incident surface side of the base substrate is provided in the screen (for example, see JP-A-20.04-45803).

However, in such a screen, since the base substrate onto which the coloring agent is supplied is positioned at its viewer side rather than the lens portion, it is difficult to heighten the contrast of the projected image sufficiently.

### SUMMARY OF THE INVENTION

It is one object of the invention to provide a method of manufacturing a microlens substrate for a transmission screen and/or a rear projection that can obtain an image having excellent contrast efficiently.

It is another object of the invention to provide the microlens substrate for a transmission screen and/or a rear projection that can obtain an image having excellent contrast.

Further, it is yet another object of the invention to provide a transmission screen and a rear projection provided with the microlens substrate.

In order to achieve the above objects, in one aspect of the present invention, the invention is directed to a method of manufacturing a microlens substrate. The microlens substrate is composed of a base substrate having two major surfaces and having light transparency and a lens portion having a plurality of microlenses. The lens portion is provided on one of the two major surfaces of the base substrate. The method includes the steps of:

preparing a substrate with concave portions having two major surfaces, a plurality of concave portions being formed on one of the two major surfaces of the substrate with concave portions;

supplying a resin material for forming the lens portion onto the one major surface of the substrate with concave portions on which the plurality of concave portions are formed, the resin material being constituted from a photopolymer having a photocuring property as a main component and containing an additive constituted from at least one of a diffusing agent and a coloring agent, the diffusing agent having a function of diffusing incident light to the resin material;

preparing the base substrate;

mounting the base substrate on the supplied resin material;

photocuring the resin material by light to form the lens portion in a state where the base substrate is in contact with the resin material, whereby the base substrate is bonded to the photocured resin material; and

removing the substrate with concave portions from the photocured resin material to obtain the microlens substrate provided with the lens portion.

This makes it possible to manufacture a microlens substrate for a transmission screen and/or a rear projection that can obtain a projected image having excellent contrast efficiently.

In the method of the invention, it is preferable that the diffusing agent includes particles constituted from polystyrene, glass or organic cross-linking polymer.

This makes it possible to prevent harmful influence on the resin material (for example, the resin material is hardly photocured, or is not photocured) from occurring in the resin material photocuring step.

In the method of the invention, it is preferable that the coloring agent includes at least one of paints and dyes.

This makes it possible to improve an affinity between the resin material and the coloring agent.

In the method of the invention, it is preferable that an amount of the additive contained in the resin material is in the range of 0.01 to 10% by weight.

This makes it possible to prevent harmful influence on the resin material (for example, the resin material is hardly photocured, or is not photocured) from occurring in the resin material photocuring step.

In the method of the invention, it is preferable that the method further includes the step of:

prior to the resin material photocuring step, attracting the coloring agent contained in the resin material toward the bottom side of each of the concave portions of the substrate with concave portions.

Thus, in the case where the manufactured microlens substrate is used in a transmission screen and/or a rear projection, it is possible to obtain a projected image having more excellent contrast.

In the method of the invention, it is preferable that the coloring agent has a magnetic property, and wherein in the coloring agent attracting step a magnetic material is prepared and placed at the side of the substrate with concave portions on which the plurality of concave portions are not formed, whereby the coloring agent is attracted toward the bottom side of each of the concave portions so as to form a layer of the coloring agent.

This makes it possible to attract the coloring agent toward the bottom side of each of the concave portions of the substrate with concave portions rapidly, and therefore, it is possible to manufacture the microlens substrate efficiently.

In the method of the invention, it is preferable that the method further includes the step of:

after the substrate removing step, applying a coloring liquid containing a coloring agent onto the one major surface of the microlens substrate on which the plurality of microlenses are provided so that the one major surface of the microlens substrate is colored with the coloring agent.

Thus, in the case where the manufactured microlens substrate is used in a transmission screen and/or a rear projection, it is possible to obtain a projected image having more excellent contrast.

In the method of the invention, it is preferable that the coloring liquid applying step is carried out by dipping.

This makes it possible to form the coloring portion (in particular, coloring portion having even density) easily and surely.

In the method of the invention, it is preferable that the substrate with concave portions is formed of a material having light transparency.

Thus, it is possible to emit the light from the point nearer to the resin material, and this makes it possible to photocure the resin material surely.

In the method of the invention, it is preferable that in the resin material photocuring step the light is entered to the resin material through the substrate with concave portions.

Thus, it is possible to emit the light from the point nearer to the resin material, and this makes it possible to photocure the resin material surely.

In the method of the invention, it is preferable that the light is ultraviolet rays.

This makes it possible to contribute to improvement of safety and cost reduction for manufacturing the microlens substrate.

In the method of the invention, it is preferable that the average thickness of the layer of the coloring agent is in the range of 1 to 200 μm.

This makes it possible to prevent harmful influence on the resin material (for example, the resin material is hardly photocured, or is not photocured) from occurring in the resin material photocuring step.

In another aspect of the invention, the invention is directed to a microlens substrate. A microlens substrate in one embodiment is manufactured using the method defined as described above.

Thus, in the case where the microlens substrate of the invention is used in a transmission screen and/or a rear projection, it is possible to obtain a projected image having more excellent contrast.

A microlens substrate in another embodiment includes:

a base substrate having two major surfaces and having light transparency; and

a lens portion provided with a plurality of microlenses, the lens portion being bonded onto one of the two major surfaces of the base substrate,

wherein the lens portion is formed of a resin material constituted from a photopolymer having a photocuring property as a main component, and the resin material contains an additive constituted from at least one of a diffusing agent and a coloring agent, in which the diffusing agent has a function of diffusing incident light to the resin material.

This makes it possible to provide a microlens substrate for a transmission screen and/or a rear projection that can obtain a projected image having excellent contrast.

In the microlens substrate of the invention, it is preferable that the lens portion is provided with a layer of the coloring agent at the side of the microlens substrate on which the plurality of microlenses are formed, and almost all the coloring agent in the lens portion is included in the layer.

Thus, in the case where the microlens substrate of the invention is used in a transmission screen and/or a rear projection, it is possible to obtain a projected image having more excellent contrast.

In yet another aspect of the invention, the invention is directed to a transmission screen including the microlens substrate defined as described above.

This makes it possible to provide a transmission screen that can obtain an image having excellent contrast.

In still another aspect of the invention, the invention is directed to a rear projection including the transmission screen defined as described above.

This makes it possible to provide a rear projection that can obtain an image having excellent contrast. The above and other objects, features, and advantages of the present invention will be apparent from the following description when taken in conjunction with the accompanying drawings which illustrate preferred embodiments of the present invention by way of example.

### BRIEF DESCRIPTION OF THE DRAWINGS

The foregoing and other objects, features and advantages of the invention will become more readily apparent from the following detailed description of preferred embodiments of the invention which proceeds with reference to the appending drawings.

FIG. 1 is a longitudinal cross-sectional view which schematically shows a microlens substrate in a first embodiment according to the invention.

FIG. 2 is a plan view of the microlens substrate shown in FIG. 1.

FIG. 3 is a longitudinal cross-sectional view which schematically shows a transmission screen provided with the microlens substrate shown in FIG. 1 in a first embodiment according to the invention.

FIG. 4 is a longitudinal cross-sectional view which schematically shows a substrate with concave portions for forming microlenses with the use of manufacturing the microlens substrate.

FIG. 5 is a longitudinal cross-sectional view which schematically shows a method of manufacturing the substrate with concave portions for forming microlenses shown in FIG. 4.

FIG. 6 is a longitudinal cross-sectional view which schematically shows each process of a method of manufacturing the microlens substrate shown in FIG. 1.

FIG. 7 is a longitudinal cross-sectional view which schematically shows each process of a method of manufacturing the microlens substrate shown in FIG. 1.

FIG. 8 is a longitudinal cross-sectional view which schematically shows each process of a method of manufacturing the microlens substrate shown in FIG. 1.

FIG. 9 is a longitudinal cross-sectional view which schematically shows each process of a method of manufacturing the microlens substrate shown in FIG. 1.

FIG. 10 is a drawing which schematically shows the configuration of a rear projection.

FIG. 11 is a longitudinal cross-sectional view which schematically shows a microlens substrate in a second embodiment according to the invention.

FIG. 12 is a longitudinal cross-sectional view which schematically shows each process of a method of manufacturing the microlens substrate shown in FIG. 11.

FIG. 13 is a longitudinal cross-sectional view which schematically shows a microlens substrate in a third embodiment according to the invention.

### DETAILED DESCRIPTION OF THE INVENTION

Preferred embodiments of a method of manufacturing a microlens substrate, a microlens substrate, a transmission screen and a rear projection according to the invention will now be described in detail with reference to the appending drawings.

### First Embodiment

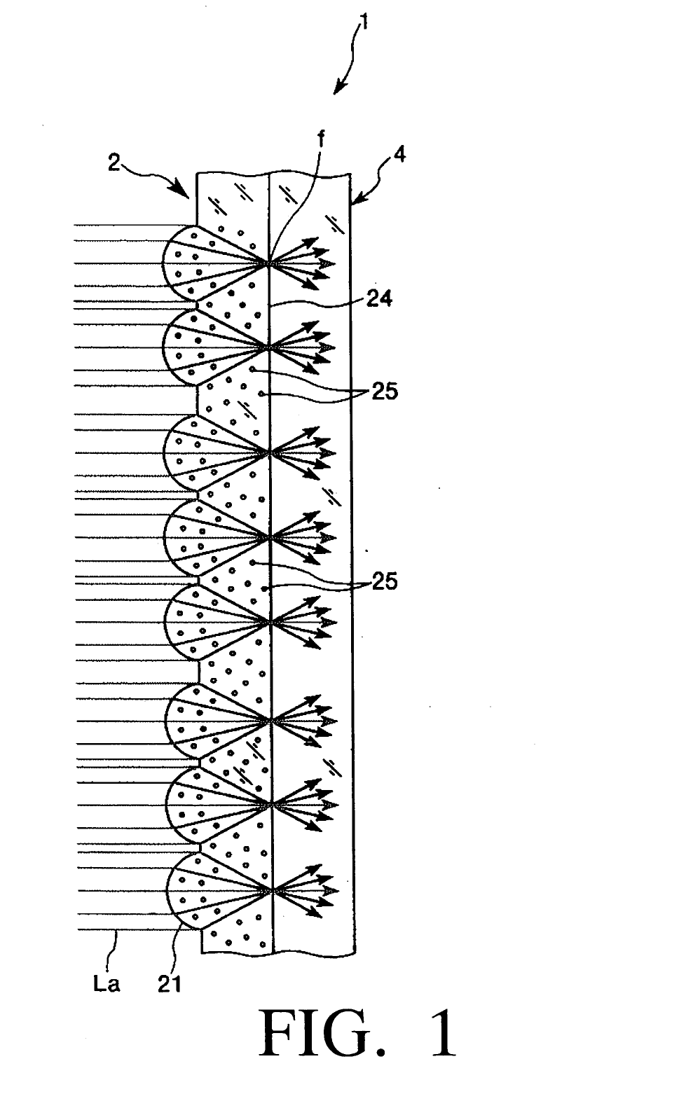

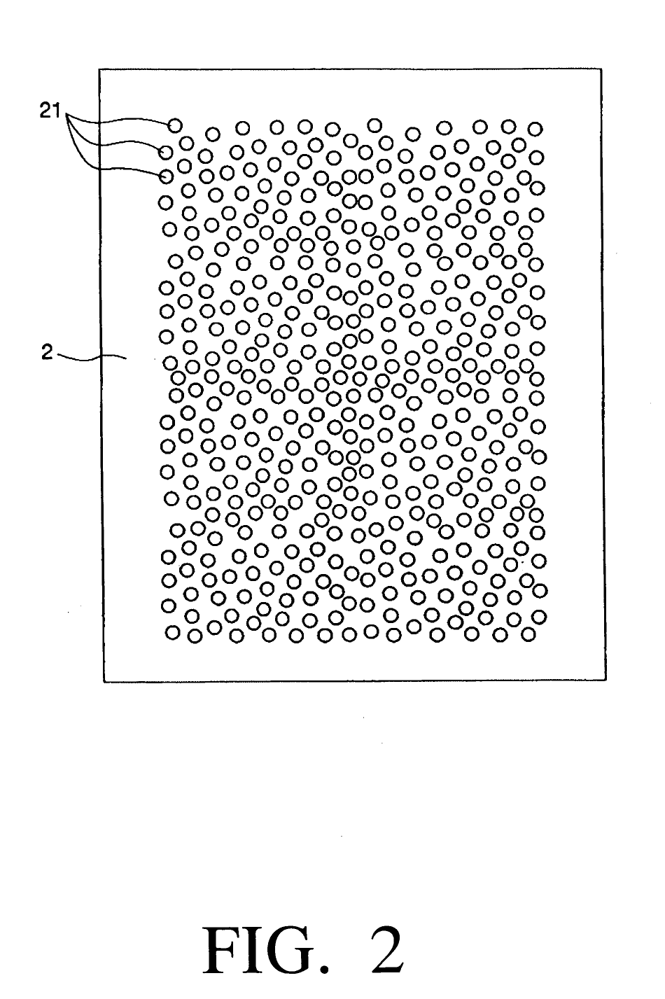

FIG. 1 is a longitudinal cross-sectional view which schematically shows a microlens substrate in a first embodiment according to the invention. FIG. 2 is a plan view of the microlens substrate shown in FIG. 1. Now, in the following explanation using FIG. 1, for convenience of explanation, a left side and a right side in FIG. 1 are referred to as a “light incident side (or light incident surface)” and a “light emission side (or light emission surface)”, respectively. In this regard, in the following description, a “light incident side” and a “light emission side” respectively indicate a “light incident side” and a “light emission side”of light for obtaining an image light, and they do not respectively indicate a “light incident side” and a “light emission side” of outside light or the like is not otherwise specified.

First, a microlens substrate 1 of the invention will now be described.

The microlens substrate (hereinafter, referred to simply as “lens substrate”) 1 is a member that is included in a transmission screen 10 (will be described later). As shown in FIG. 1, the microlens substrate 1 is provided with a base substrate 4 having two major surfaces and light transparency, and a lens portion 2 provided at the light incident surface side (one major surface) of the base substrate 4.

The base substrate 4 has a flat shape. Although the constituent material of the base substrate 4 is not particularly limited, it is constituted from a transparent resin material having an even index of refraction as a main component.

As for the concrete constituent material of the base substrate 4, for example, polyolefin such as polyethylene, polypropylene, ethylene-propylene copolymer, ethylene-vinyl acetate copolymer (EVA) and the like, cyclic polyolefin, denatured polyolefin, polyvinyl chloride, polyvinylidene chloride, polystyrene, polyamide (such as nylon 6, nylon 46, nylon 66, nylon 610, nylon 612, nylon 11, nylon 12, nylon 6-12, nylon 6-66), polyimide, polyamide-imide, polycarbonate (PC), poly-(4-methylpentene-1), ionomer, acrylic resin, acrylonitrile-butadiene-styrene copolymer (ABS resin), acrylonitrile-styrene copolymer (AS resin), butadiene-styrene copolymer, polyoxymethylene, polyvinyl alcohol (PVA), ethylene-vinyl alcohol copolymer (EVOH), polyester such as polyethylene terephthalate (PET), polybutylene terephthalate (PBT), and polycyclohexane terephthalate (PCT), polyether, polyether ketone (PEK), polyether ether ketone (PEEK), polyether imide, polyacetal (POM), polyphenylene oxide, denatured polyphenylene oxide, polysulfone, polyether sulfone, polyphenylene sulfide, polyarylate, liquid crystal polymer such as aromatic polyester, fluoro resins such as polytetrafluoroethylene (PTFE), polyfluorovinylidene and the like, various thermoplastic elastomers such as styrene based elastomer, polyolefin based elastomer, polyvinylchloride based elastomer, polyurethane based elastomer, polyester based elastomer, polyamide based elastomer, polybutadiene based elastomer, trans-polyisoprene based elastomer, fluorocarbon rubber based elastomer, chlorinated polyethylene based elastomer and the like, epoxy resins, phenolic resins, urea resins, melamine resins, unsaturated polyester, silicone based resins, urethane based resins, and the like; and copolymers, blended bodies and polymer alloys and the like having at least one of these materials as a main ingredient may be mentioned. Further, in this invention, a mixture of two or more kinds of these materials may be utilized (for example, a blended resin, a polymer alloy, a laminate body comprised of two or more layers using two or more of the materials mentioned above). Among these materials, from viewpoint of transparency, it is preferable that the constituent material of the base substrate 2 is any one of polystyrene, polycarbonate, polyethylene terephthalate, and an acrylic based resin, and more preferably it is an acrylic based resin, in particular. Since the acrylic based resin has excellent heat resistance, light resistance and workability, dimensional accuracy and mechanical strength when it is formed in addition to excellent transparency, the acrylic based resin is suitable for the constituent material of the base substrate 4. Therefore, by using the base substrate 4 formed of the acrylic based resin as a main material in the invention, it is possible to provide a lens substrate (microlens substrate 1) having excellent various characteristics and reliability, in particular. Further, since the acrylic based resin is normally relatively cheapness, it is advantageous in view of the manufacturing costs of the microlens substrate 1.

As for the acrylic based resin, for example, acrylic resin including acrylic acid or an inducer thereof (for example, acrylic ester) as a constituent monomer, methacrylic resin including methacrylic acid or an inducer thereof (for example, methacrylic acid ester) as a constituent monomer, copolymer including acrylic (methacrylic) acid or an inductor thereof as a constituent monomer such as styrene-acrylic ester copolymer, styrene-methacrylic acid ester copolymer, styrene-acrylic ester-methacrylic acid ester copolymer, styrene-α-chloro acrylic methyl copolymer, styrene-acrylonitrile-acrylic ester copolymer, and the like may be mentioned. One kind of them or a combination of two or more kinds selected from them may be utilized.

As shown in FIG. 2, the lens portion 2 has a plurality of microlenses (convex lenses) 21.

It is preferable that the average diameter of each of the microlenses 21 is in the range of 10 to 500 μm, and more preferably it is in the range of 30 to 300 μm, and further more preferably it is in the range of 50 to 100 μm. By restricting the average diameter of each of the microlenses 21 within the above ranges, it is possible to further enhance the productivity of the microlens substrate 1 (transmission screen 10 provided with the microlens substrate 1) while maintaining sufficient resolution in the image projected on the screen. In this regard, it is preferable that the pitch between adjacent microlenses 21 in the microlens substrate 1 is in the range of 10 to 500 μm, more preferably the pitch is in the range of 30 to 300 μm, and further more preferably the pitch is in the range of 50 to 100 μm.

Further, it is preferable that the average radius of curvature of each of the plurality of microlenses 21 is in the range of 5 to 250 μm, and more preferably it is in the range of 15 to 150 μm. Most preferably it is in the range of 25 to 50 μm. By restricting the average radius of curvature of each of the microlenses 21 within the above ranges, it is possible to particularly improve the angle of view characteristics. In particular, it is possible to improve the angle of view characteristics in the horizontal direction and the vertical direction.

Moreover, an arrangement pattern of the microlenses 21 is not particularly limited. The arrangement pattern may be either an arrangement pattern in which the microlenses 21 are arranged in a regular manner (for example, a lattice-shaped manner, honeycomb-shaped manner, houndstooth check manner) or an arrangement pattern in which the microlenses 21 are arranged in an optically random manner (the microlenses 21 are randomly arranged with each other when viewed from above the light incident surface (one major surface) of the microlens substrate 1). However, it is preferable that the microlenses 21 are arranged in a random manner as shown in FIG. 2. In the case where the microlenses 21 are arranged in such a random manner, it is possible to prevent interference of the light to a light valve of a liquid crystal or the like and a Fresnel lens from occurring more efficiently, and therefore it is possible to prevent moire from occurring almost completely. This makes it possible to obtain an excellent transmission screen 10 having a high display quality. In this regard, a term “in an optically random order” in the specification means that a plurality of microlenses 21 are arranged irregularly or at random so that it is possible to prevent and suppress occurrence of optical interference such as moire sufficiently.

Furthermore, as shown in FIG. 1, each of the microlenses 21 is formed as a convex lens which protrudes toward the light incident side of the microlens substrate 1, and is designed so that the focal point f thereof is positioned in the vicinity of the light emission surface 24 of the microlens substrate 1. In other words, parallel light La that enters the microlens substrate 1 from a direction substantially perpendicular to the microlens substrate 1 (parallel light La from a Fresnel lens 5 as will be described later) is condensed by each of the microlenses 21 of the microlens substrate 1, and is focused on the focal point f in the vicinity of the light emission surface 24 of the microlens substrate 1.

Further, it is preferable that the ratio of an area (projected area) occupied by all the microlenses (convex lenses) 21 in a usable area where the microlenses 21 are formed with respect to the entire usable area is 90% or more when viewed from above the light incident surface of the microlens substrate 1 (that is, a direction shown in FIG. 2). More preferably the ratio is 96% or more. In the case where the ratio of the area occupied by all the microlenses (convex lenses) 21 in the usable area with respect to the entire usable area is 90% or more, it is possible to reduce straight light passing through an area other than the area where the microlenses 21 reside, and this makes it possible to enhance the light use efficiency of the transmission screen 10 provided with the microlens substrate 1 further.

The lens portion 2 is formed of a resin material 23 constituted from photopolymer having photocuring property as a main component, and the resin material 23 contains an additive constituted from at least one of a diffusing agent 25. In this regard, the diffusing agent 25 has a function of diffusing incident light to the microlens substrate 1 from a light source.

Further, the diffusing agent 25 exists in the whole photocured resin material 23 (the entire lens portion 2) substantially evenly (with substantially even density thereof) (see FIGS. 1 and 2).

The diffusing agent 25 is not particularly limited, but, for example, particles (beads) constituted from polystyrene, glass or organic cross-linking polymer may be used for the diffusing agent 25. Thus, it is possible to diffuse the incident light suitably. This makes it possible to prevent and suppress occurrence of optical interference such as moire sufficiently. Further, in the case where the microlens substrate 1 is applied to a transmission screen 10, it is possible to obtain a projected image having excellent contrast.

Next, a transmission screen 10 provided with the microlens substrate 1 as described above will now be described.

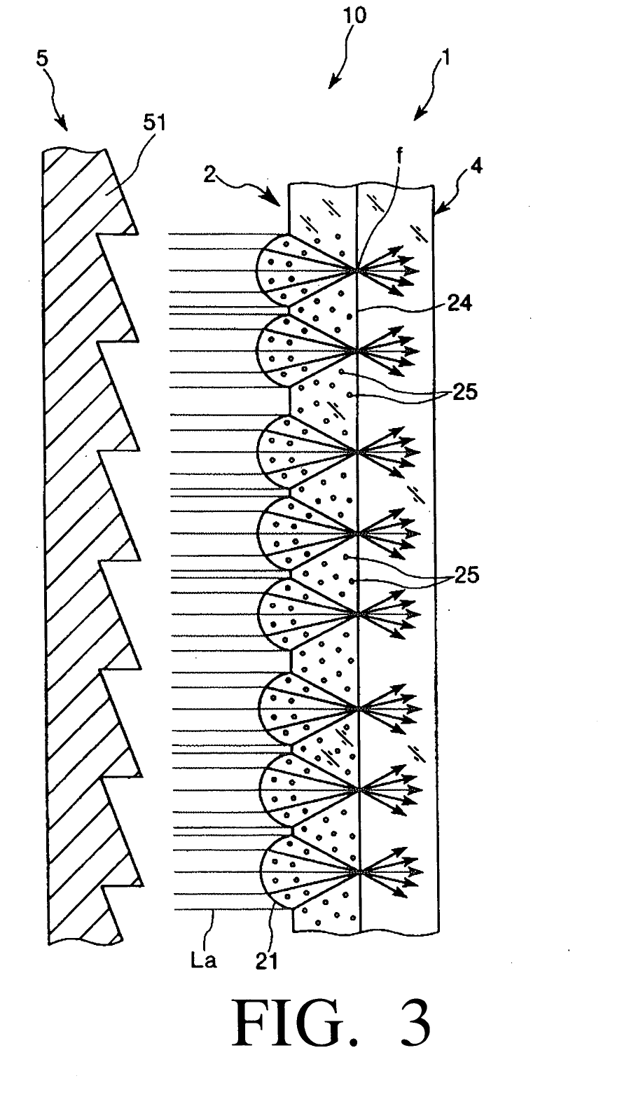

FIG. 3 is a longitudinal cross-sectional view which schematically shows a transmission screen 10 provided with the microlens substrate 1 shown in FIG. 1 in a first embodiment according to the invention. Now, in the following explanation using FIG. 3, for convenience of explanation, a left side and a right side in FIG. 3 are referred to as a “light incident side (or light incident surface)” and a “light emission side (or light emission surface)”, respectively. As shown in FIG. 3, the transmission screen 10 is provided with a Fresnel lens 5 and the microlens substrate 1 described above. The Fresnel lens 5 is arranged on the side of the light incident surface of the microlens substrate 1 (that is, on the incident side of light for an image), and the transmission screen 10 is constructed so that the light that has been transmitted by the Fresnel lens 5 enters the microlens substrate 1.

The Fresnel lens 5 is provided with a plurality of prisms that are formed on a light emission surface of the Fresnel lens 5 in a substantially concentric manner. The Fresnel lens 5 deflects the light for a projected image from a projection lens (not shown in the drawings), and outputs parallel light La that is parallel to the perpendicular direction of the major surface of the microlens substrate 1 to the side of the light incident surface of the microlens substrate 1.

In the transmission screen 10 constructed as described above, the image light from the projection lens is deflected by the Fresnel lens 5 to become the parallel light La. Then, the parallel light La enters the microlens substrate 1 from the light incident surface on which the plurality of microlenses 21 are formed to be condensed by each of the microlenses 21 of the microlens substrate 1, and the condensed light then passes through the base substrate 4 to be outputted. At this time, the light entering the microlens substrate 1 penetrates through the microlens substrate 1 with sufficient transmittance and the light penetrating the base substrate 4 is then diffused, whereby an observer (viewer) of the transmission screen 10 observes (watches) the light as a flat image.

Further, since the diffusing agent 25 is provided in the lens portion 2 of the microlens substrate 1 as described above, it is possible to diffuse the incident light suitably. Thus, the transmission screen 10 can have excellent contrast.

Next, a method of manufacturing the microlens substrate 1 described above will now be described.

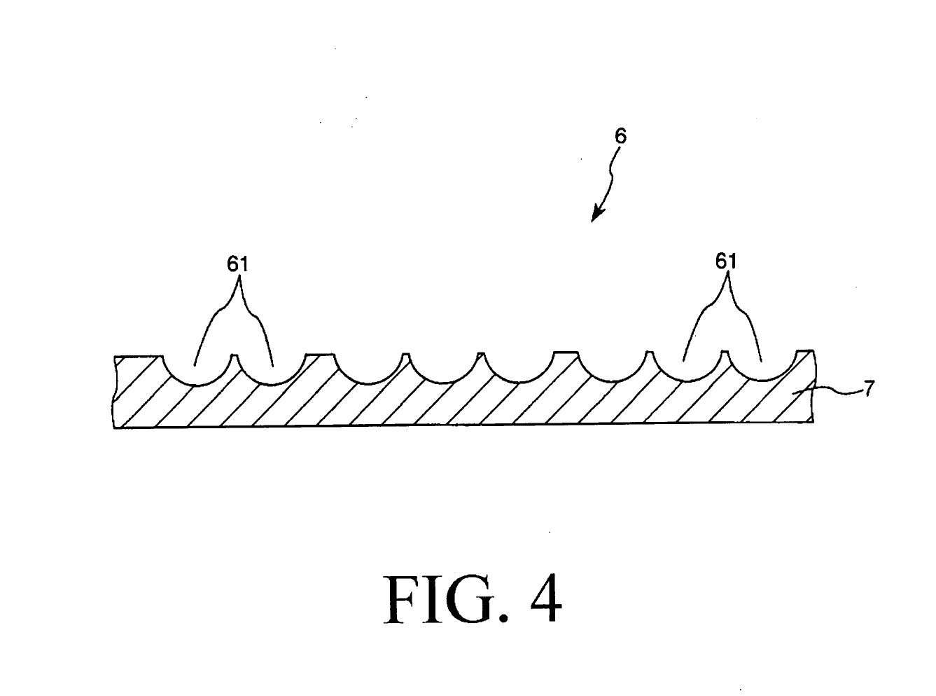

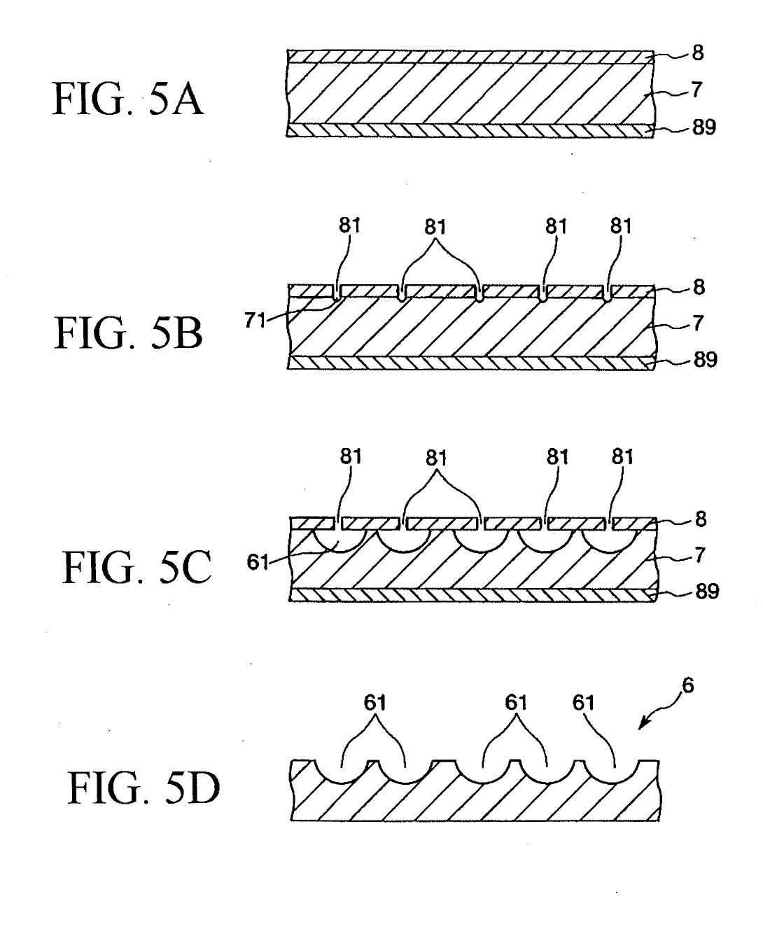

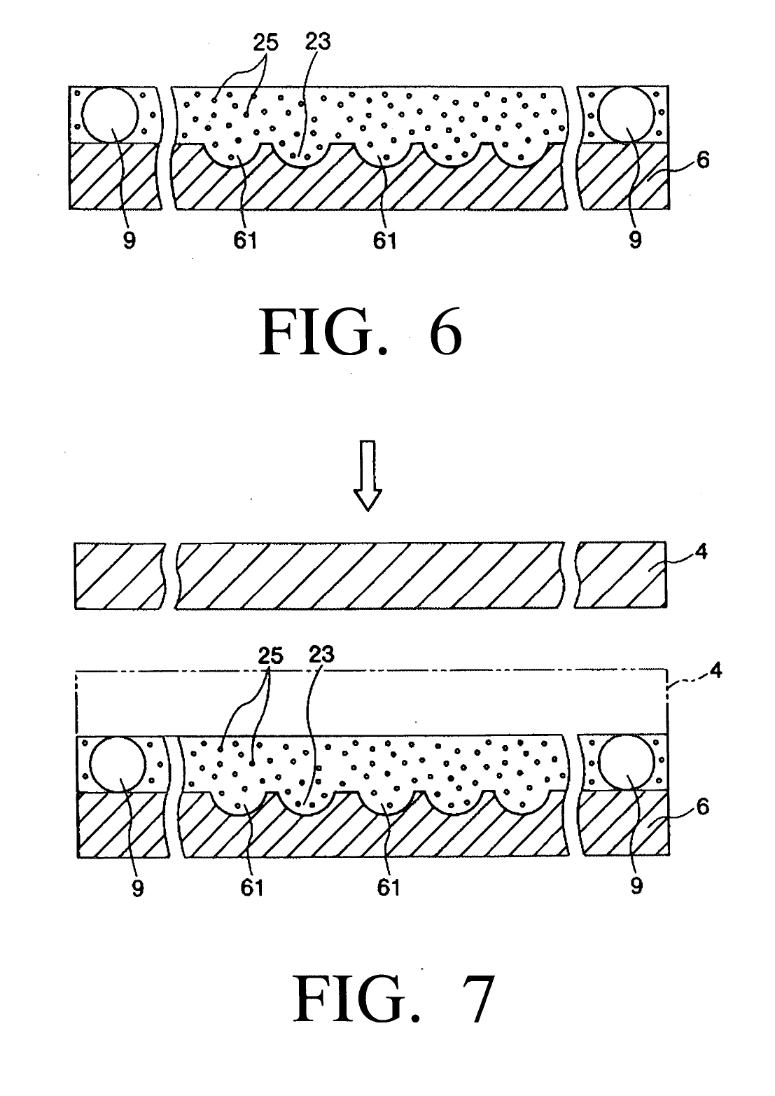

FIG. 4 is a longitudinal cross-sectional view which schematically shows a substrate with concave portions for forming microlenses with the use of manufacturing the microlens substrate. FIG. 5 is a longitudinal cross-sectional view which schematically shows a method of manufacturing the substrate with concave portions for forming microlenses shown in FIG. 4. FIGS. 6 through 9 are longitudinal cross-sectional views which schematically show processes of a method of manufacturing the microlens substrate shown in FIG. 1. In this regard, in the following description, the lower side and upper side in FIGS. 6 through 9 are referred to as a “light incident side (or light incident surface)” and a “light emission side (or light emission surface)”, respectively.

Further, a large number of concave portions for forming microlenses 21 are actually formed on a substrate in manufacturing the substrate 6 with concave portions for forming microlenses 21, and a large number of convex portions (convex lenses) are actually formed on a substrate in manufacturing the microlens substrate 1. However, in order to make the explanation understandable, a part of each of the substrate 6 with concave portions for forming microlenses 21 and the microlens substrate 1 is shown so as to be emphasized in FIGS. 4 to 9.

First, a structure of the substrate 6 with concave portions for forming microlenses 21 used to manufacture the microlens substrate 1 and a method of manufacturing the same will be described prior to the description of a method of manufacturing the microlens substrate 1.

As shown in FIG. 4, a substrate 6 with concave portions for forming microlenses 21 has a large number of concave portions (for forming microlenses 21) 61 arranged thereon in a random manner.

By using such a substrate 6 with concave portions for forming microlenses 21, it is possible to obtain a microlens substrate 1 on which a plurality of microlenses 21 are arranged in a random manner as described above. In this regard, a term “in an optically random order” in the specification means that a plurality of microlenses 21 are arranged irregularly or at random so that it is possible to prevent and suppress occurrence of optical interference such as moire sufficiently.

Next, one example of the method of manufacturing the substrate 6 with concave portions for forming microlenses 21 will be described with reference to FIG. 5. In this regard, although a large number of concave portions 61 for forming microlenses 21 are actually formed on the substrate, only a part of them will be exaggeratedly shown in order to simplify the explanation thereof.

First, a substrate 7 is prepared in manufacturing the substrate 6 with concave portions 61 for forming microlenses 21. It is preferable that a substrate having a uniform thickness without flexure and blemishes is used for the substrate 7. Further, it is also preferable that a substrate with a surface cleaned by washing or the like is used for the substrate 7.

Although soda-lime glass, crystalline glass, quartz glass, lead glass, potassium glass, borosilicate glass, alkali-free glass and the like may be mentioned as for a constituent material for the substrate 7, soda-lime glass, crystalline glass (for example, neoceram or the like) and alkali-free glass are preferable among them. By constituting the substrate 7 from soda-lime glass, crystalline glass or alkali-free glass, the substrate 7 (the substrate 6 with concave portions 61 for forming microlenses 21) can have light transparency.

<A1> As shown in FIG. 5A, a mask 8 is formed on the surface of the prepared substrate 7 (mask formation process). Then, a back surface protective film 89 is formed on the back surface of the substrate 7 (that is, the surface side opposite to the surface on which the mask 8 is formed). Needless to say, the mask 8 and the back surface protective film 89 may be formed simultaneously. It is preferable that the mask 8 permits initial holes 81 (will be described later) to be formed therein by means of irradiation with laser beams or the like, and has resistance to etching at an etching process (will be described later). In other words, it is preferable that the mask 8 is constituted so that an etching rate for the mask 8 is nearly equal to or smaller than that for the substrate 7.

From such a viewpoint, for example, metals such as Cr, Au, Ni, Ti, Pt, and the like, metal alloys containing two or more kinds of metals selected from these metals, oxides of these metals (metal oxides), silicon, resins, and the like may be mentioned as a constituent material for the mask 8. Alternatively, the mask 8 may be given to a laminated structure by a plurality of layers formed of different materials such as a Cr/Au or chromium oxide/Cr laminate.

The method of forming the mask 8 is not particularly limited. In the case where the mask 8 is constituted from any of metal materials (including metal alloys) such as Cr and Au or metal oxides such as chromium oxide, the mask 8 can be suitably formed by means of an evaporation method, a sputtering method, or the like, for example. On the other hand, in the case where the mask 8 is formed of silicon, the mask 8 can be suitably formed by means of a sputtering method, a CVD method, or the like, for example.

Although the thickness of the mask 8 varies depending upon the material constituting the mask 8, it is preferable that the thickness of the mask 8 is in the range of 0.01 to 2.0 μm, and more preferably it is in the range of 0.03 to 0.2 μm. In the case where the thickness of the mask 8 is below the lower limit given above, there is a possibility to deform the shapes of the initial holes 81 formed at the initial hole formation process (will be described later). In addition, there is a possibility that sufficient protection for the masked portion of the substrate 7 cannot be obtained during a wet etching process at the etching process (will be described later). On the other hand, in the case where the thickness of the mask 8 is over the upper limit given above, in addition to the difficulty in formation of the initial holes 81 that penetrate the mask 8 at the initial hole formation process (will be described later), there will be a case in which the mask 8 tends to be easily removed due to internal stress thereof depending upon the constituent material or the like of the mask 8.

The back surface protective film 89 is provided for protecting the back surface of the substrate 7 at the subsequent processes. Erosion, deterioration or the like of the back surface of the substrate 7 can be suitably prevented by means of the back surface protective film 89. Since the back surface protective film 89 is formed using the same material as the mask 8, it may be provided in a manner similar to the formation of the mask 8 simultaneously with the formation of the mask 8.

<A2> Next, as shown in FIG. 5B, the plurality of initial holes 81 that will be utilized as mask openings at the etching process (will be described later) are formed in the mask 8 in a random manner (initial hole formation process). Although the initial holes 81 may be formed in any method, it is preferable that the initial holes 81 are formed by the physical method (such as a blast process and an etching process) or the irradiation with laser beams (such as a ruby laser and a semiconductor laser). This makes it possible to manufacture the substrate 6 with concave portions for forming microlenses 21 with high productivity. In particular, the concave portions 61 can be easily formed on a relatively large-sized substrate 7.

It is preferable that the initial holes 81 are formed uniformly on the entire surface of the mask 8. Further, it is preferable that the initial holes 81 are formed in such a manner in which small holes are arranged at predetermined regular intervals so that there is no flat portion on the surface of the substrate 7 to be formed, and so that the surface of the substrate 7 is covered with concave portions 61 with almost no space when subjecting the substrate 7 with the mask 8 to an etching process at step <A3> (will be described later).

When the initial holes 81 are formed in the mask 8, as shown in FIG. 5B, the initial concave portions 71 may also be formed in the substrate 7 by removing parts of the surface of the substrate 7 in addition to the initial holes 81. This makes it possible to increase a contact area of the substrate 7 with an etchant when subjecting the substrate 7 with the mask 8 to the etching process (will be described later), whereby erosion can be made to start suitably. Further, by adjusting the depth of each of the initial concave portions 71, it is also possible to adjust the depth of each of the concave portions 61 (that is, the maximum thickness of the microlens 21). Although the depth of each of the initial concave portions 71 is not particularly limited, it is preferable that it is 5.0 μm or less, and more preferably the depth is in the range of about 0.1 to 0.5 μm.

<A3> Next, as shown in FIG. 5C, a large number of concave portions 61 are formed in the substrate 7 in a random manner by subjecting the substrate 7 to the etching process using the mask 8 in which the initial holes 81 are formed (etching process). The etching method is not particularly limited, and as for the etching method, a wet etching process, a dry etching process and the like may be mentioned, for example. In the following explanation, the case of using the wet etching process will be described as an example.

By subjecting the substrate 7 covered with the mask. 8 in which the initial holes 81 are formed to the wet etching process, as shown in FIG. 5C, the substrate 7 is eroded from the portions where no mask 8 is present, whereby a large number of concave portions 61 are formed in the substrate 7. As mentioned above, since the initial holes 81 formed in the mask 8 are arranged in a random manner, the concave portions 61 to be formed are also arranged on the surface of the substrate 7 in a random manner.

Further, in the present embodiment, the initial concave portions 71 are formed on the surface of the substrate 7 when the initial holes 81 are formed in the mask 8 at step <A2>. This makes the contact area of the substrate 7 with the etchant to increase during the etching process, whereby erosion can be made to start suitably. Moreover, the concave portions 61 can be formed suitably by employing the wet etching process. In the case where an etchant containing hydrofluoric acid (hydrogen fluoride) (that is, hydrofluoric acid-based etchant) is utilized as an etchant, for example, the substrate 7 can be eroded more selectively, and this makes it possible to form the concave portions 61 suitably.

<A4> Next, the mask 8 is removed as shown in FIG. 5D (mask removal process). At this time, the back surface protective film 89 is also removed along with the mask 8.

As a result of the processes in the above, as shown in FIGS. 5D and 4, a substrate 6 with concave portions for forming microlenses 21 in which a large number of concave portions 61 are formed in the substrate 7 in a random manner is obtained.

Next, the method of manufacturing the microlens substrate 1 using the substrate 6 with concave portions for forming microlenses 21 described above will now be described.

<B1> As shown in FIG. 6, a (uncured) resin material 26 having fluidity is supplied to the surface of the substrate 6 with concave portions for forming microlenses 21 on which the concave portions 61 are formed (resin material supplying process). The resin material 23 is constituted from a photopolymer having a photocuring property as a main component, and contains a diffusing agent 25.

In this regard, it is preferable that the content by percentage of the diffusing agent 25 contained in the resin material 23 (that is, an amount of the diffusing agent 25 contained in the resin material 23) is in the range of 0.01 to 10% by weight, and more preferably it is in the range of 0.1 to 1.0% by weight. In the case where the content by percentage of the diffusing agent 25 is restricted within the above ranges, it is possible to prevent harmful influence on the resin material 23 from occurring when photocuring the resin material 23 at a resin material photocuring process (for example, the resin material 23 is hardly photocured, or is not photocured).

Further, in the case where the particles constituted from polystyrene, glass or organic cross-linking polymer is used as the diffusing agent 25 as described above, it is possible to prevent harmful influence on the resin material 23 from occurring when photocuring the resin material 23 (for example, the resin material 23 is hardly photocured, or is not photocured).

Moreover, although the average grain diameter of the diffusing agent 25 is not particularly limited, for example, it is preferable that it is in the range of 1 to 20 μm, and more preferably it is in the range of 3 to 10 μm. In the case where the average grain diameter of the diffusing agent 25 is restricted within the above ranges, it is possible to diffuse the incident light suitably while preventing or suppressing light transparency of the lens portion 2 to be obtained finally from being spoiled. Further, it is possible to prevent harmful influence on the resin material 23 from occurring when photocuring the resin material 23 (for example, the resin material 23 is hardly photocured, or is not photocured).

Furthermore, in the present embodiment, at this step, spacers 9 are provided at a region where the concave portions 61 of the substrate 6 with concave portions for forming microlenses 21 are not formed, and the resin material 23 is then pressed (or pushed) by means of the base substrate 4 at subsequent step (mounting process). Thus, it is possible to control the thickness of the lens portion 2 to be formed more surely, and this makes it possible to control the focal points f of the respective microlenses 21 in the microlens substrate 1 to be finally obtained more surely.

In the case where the spacers 9 are used as the present embodiment, the shape of each of the spacers 9 is not particularly limited, but it is preferable that it is a substantially spherical shape or substantially cylindrical shape. In the case where the spacer 9 has such a shape, it is preferable that the diameter of each of the spacers 9 is in the range of 10 to 300 μm, and more preferably it is in the range of 30 to 200 μm. Further more preferably, it is in the range of 30 to 170 μm.

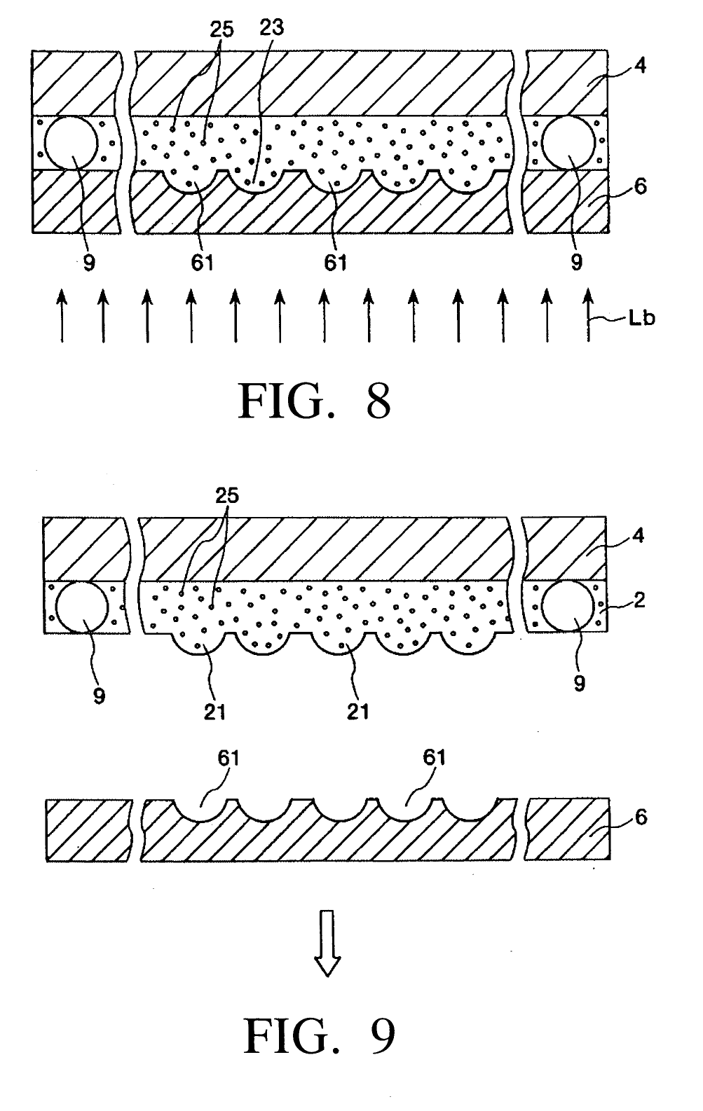

In this regard, prior to the application of the resin material 23, a mold release agent or the like may be applied to the surface of the substrate 6 with concave portions for forming microlenses 21 on which the concave portions 61 are formed. This makes it possible to separate the lens portion 2 from the substrate 6 with concave portions for forming microlenses 21 easily and surely at the subsequent step (removing process).

<B2> Next, as shown in FIG. 7, the base substrate 4 is mounted (that is, covered) on the resin material 23 (mounting process). At that time, the resin material 23 is pushed (pressed) by means of the base substrate 4. This makes it possible to closely stick the base substrate 4 to the resin material 23 surely, and therefore, it is possible to bond the resin material 23 to be photocured, that is, the lens portion 2 to be obtained finally, to the base substrate 4 surely.

<B3> Next, the resin material 23 is photocured (resin material photocuring process). As shown in FIG. 8, at the present step, light Lb is emitted (entered) to the resin material 23 through the substrate 6 with concave portions. Since the substrate 6 with concave portions for forming microlenses 21 has light transparency, it is possible to emit the light Lb to the resin material 23 from the side of the substrate 6 with concave portions for forming microlenses 21 in a state where the base substrate 4 is in contact with the resin material 23. Since the light Lb can be emitted to the resin material 23, a light source can be provided on (or embedded in) a stage (not shown in the drawings) on which the substrate 6 with concave portions for forming microlenses 21 is to be mounted, for example. Therefore, it is possible to emit the light Lb to the resin material 23 from more close side with respect to the resin material 23. This makes it possible to photocure the resin material 23 surely. Further, the resin material 23 is bonded to the base material 4 while photocuring the resin material 23. In this regard, the light Lb to be emitted is not particularly limited. For example, ultraviolet rays, ionizing radiation, laser and the like may be mentioned. From the viewpoint of improvement of safety and cut-down of the manufacturing costs, it is preferable to use ultraviolet rays.

<B4> Next, as shown in FIG. 9, the substrate 6 with concave portions for forming microlenses 21 is removed from the photocured resin material 23 (removing process).

Through the processes as described above, the microlens substrate 1 provided with the lens portion 2 having a function of diffusing incident light is obtained efficiently and surely.

Hereinafter, a description will be given for a rear projection using the transmission screen described above.

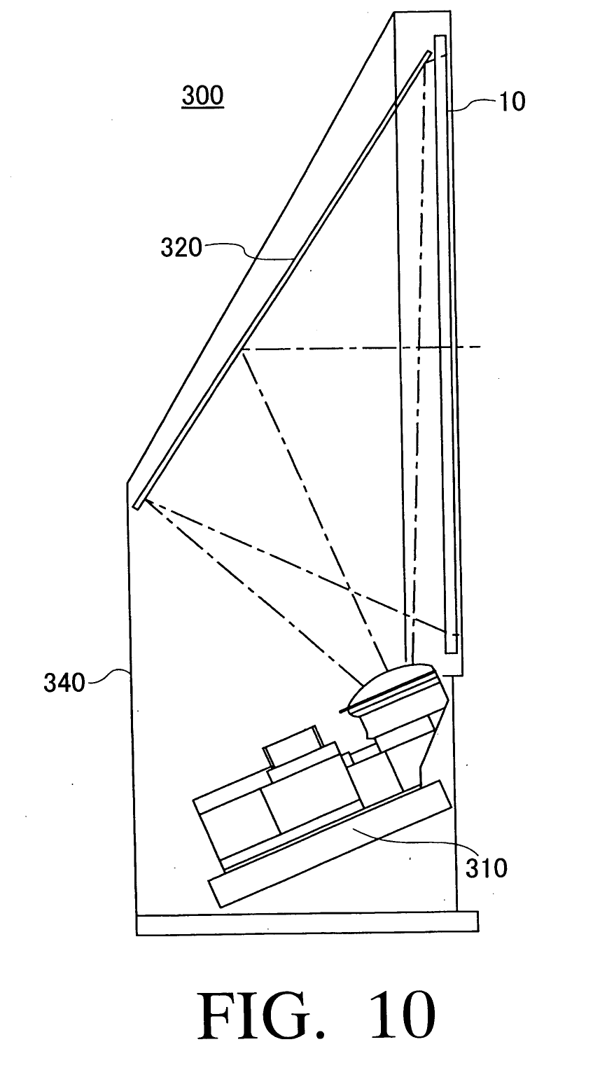

FIG. 10 is a cross-sectional view which schematically shows a rear projection 300 to which the transmission screen 10 of the invention is applied. As shown in FIG. 10, the rear projection 300 has a structure in which a projection optical unit 310, a light guiding mirror 320 and a transmission screen 10 are arranged in a casing 340.

Since the rear projection 300 is provided with the transmission screen 10 as described above, it is possible to obtain a projected image having excellent contrast. In addition, since the rear projection 300 has the configuration as described above in the present embodiment, it is possible to obtain excellent angle of view characteristics and light use efficiency, in particular.

Further, since the microlenses 21 are optically arranged in a random manner on the microlens substrate 1 described above, the rear projection 300 hardly generates problems such as moire extremely.

### Second Embodiment

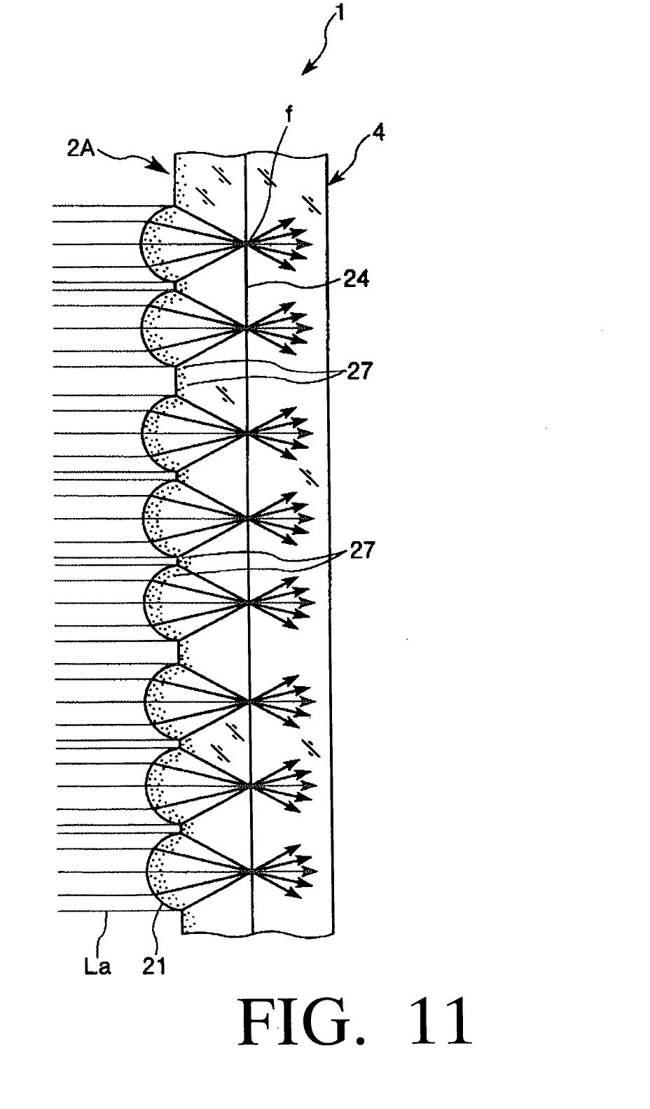

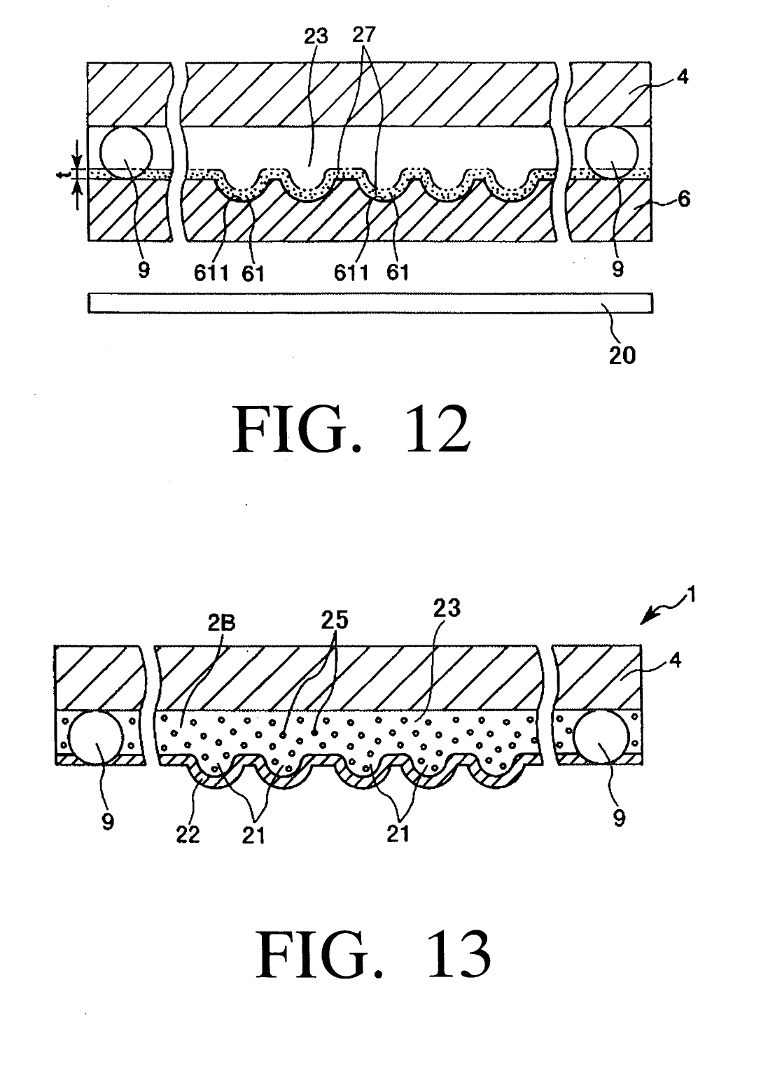

FIG. 11 is a longitudinal cross-sectional view which schematically shows a microlens substrate in a second embodiment according to the invention. FIG. 12 is a longitudinal cross-sectional view which schematically shows each process of a method of manufacturing the microlens substrate shown in FIG. 11. In this regard, in the following explanation using FIG. 12, for convenience of explanation, a lower side and an upper side in FIG. 12 are referred to as a “light incident side (or light incident surface)” and a “light emission side (or light emission surface)”, respectively.

Hereinafter, an explanation will be given for a microlens substrate of the second embodiment with reference to FIGS. 11 and 12; however, differences between the first embodiment described above and the second embodiment are chiefly described, and the description of the similar portions is omitted. The microlens substrate in the present embodiment is similar to that in the first embodiment described above except for the configuration of a lens portion.

As shown in FIG. 11, a lens portion 2A is formed of a photocured resin material 23 containing a coloring agent 27 as an additive. The coloring agent 27 is arranged at the side of the lens portion 2A in the microlens substrate 1 on which the plurality 2 of microlenses 21 are formed (that is, the coloring agent 27 is unevenly distributed at the side of apex of each of the microlenses 21).

Further, the coloring agent 27 can transmit incident light to the microlens substrate 1 from a light incident side thereof sufficiently, and has a function of preventing outside light (for example, outside light entering the microlens substrate 1 from a light emission side thereof or the like unwillingly) from being reflected to the light emission side thereof. Since the coloring agent 27 is unevenly distributed at the light incident side of the microlens substrate 1 (that is, at the light incident side of each of the microlenses 21), it is possible to obtain a projected image having more excellent contrast.

In this regard, the color of the coloring agent 27 is not particularly limited. It is preferable that the color of the coloring agent 27 is an achromatic color, particularly black as appearance using a coloring agent in which the color thereof is based on blue and red, brown or yellow is mixed therein. Further, it is preferable that light having specific wavelengths for controlling balance of light's three primary colors (RGB) of a light source is selectively absorbed in the coloring agent 27 or penetrates the coloring agent 27. This makes it possible to prevent the outside light from being reflected. The tone of color of the image formed from the light penetrating the microlens substrate 1 can be expressed exactly, and chromatic coordinate is widened (the width of expression of the tone of color is made to widen sufficiently), and therefore a darker black can be expressed. As a result, it is possible to improve the contrast of the image, in particular.

Next, a description will be given for a method of manufacturing the microlens substrate 1 having the lens portion 2A in which a coloring agent 27 is arranged at the side of the lens portion 2A in the microlens substrate 1 on which the plurality 2 of microlenses 21 are formed.

The method of manufacturing the microlens substrate 1 of the present embodiment is similar to the method of manufacturing a microlens substrate in the first embodiment except that the method further includes a coloring agent attracting process. In the coloring agent attracting process, prior to the resin material photocuring process ([B3] in the first embodiment described above), the coloring agent 27 in the resin material 23 is attracted toward (or unevenly distributed at) the bottom portion 611 side of each of the concave portions 61 in the substrate 6 with concave portions for forming microlenses 21, that is, toward the light incident side of the microlens substrate 1 to be manufactured (see FIG. 12).

Further, the coloring agent 27 is not particularly limited, but for example, it is preferable to use any one of various paints as the coloring agent 27. By using any one of various paints as the coloring agent 27, it is possible to improve an affinity between the resin material 23 and the coloring agent 27. Thus, the coloring agent 27 can become a diffused state in which the coloring agent 27 is evenly diffused in the resin material 23 supplied in the resin material supplying process ([B1] in the first embodiment described above). By carrying out the coloring agent attracting process in this state, it is possible to form a layer of the coloring agent 27 having a substantially even thickness t in the resin material 23 (that is, lens portion 2A).

In this case, it is preferable that the average thickness t of the layer of the coloring agent 27 is in the range of 1 to 200 μm, and more preferably it is in the range of 2 to 80 μm. In the case where the average thickness t is restricted within the above ranges, it is possible to prevent a harmful influence on the resin material 23 (for example, deterioration of the constituent material of the lens portion 2A) from being generated sufficiently when the resin material 23 is photocured by irradiating light from the light incident side of the microlens substrate to be formed (that is, in the resin material photocuring process).

Further, it is preferable that the coloring agent 27 has a magnetic property. In the case where the coloring agent 27 has a magnetic property, it is possible to attract the coloring agent 27 toward the light incident side of the microlens substrate 1 to be formed (that is, to unevenly distributed at the light incident side of the microlens substrate 1) by preparing a magnetic material (or magnet) 20 and placing it at the side of the substrate 6 with concave portions on which the plurality of concave portions 61 are not formed as shown in FIG. 12. Thus, it is possible to unevenly distribute the coloring agent 27 toward the light incident side of the microlens substrate 1 rapidly, and this makes it possible to manufacture the microlens substrate 1 efficiently.

Moreover, the coloring agent attracting process is not limited to the method of attracting the coloring agent 27 toward the light incident side of the microlens substrate 1 to be manufactured by means of the magnetic element 20 as shown in FIG. 12, and for example, the coloring agent 27 may be attracted toward the light incident side by sedimenting the coloring agent 27 by itself.

### Third Embodiment

FIG. 13 is a longitudinal cross-sectional view which schematically shows a microlens substrate in a third embodiment according to the invention. In this regard, in the following explanation using FIG. 13, for convenience of explanation, a lower side and an upper side in FIG. 13 are referred to as a “light incident side (or light incident surface)” and a “light emission side (or light emission surface)”, respectively.

Hereinafter, an explanation will be given for a microlens substrate of the third embodiment with reference to FIG. 13; however, differences between the first embodiment described above and the third embodiment are chiefly described, and the description of the similar portions is omitted.

The microlens substrate in the present embodiment is similar to that in the first embodiment described above except for the configuration of a lens portion.

As shown in FIG. 13, a colored portion (outside light absorbing portion) 22 is provided at the light incident side of the lens portion 2B (that is, at the light incident side of each of the microlenses 21). The light entering the microlens substrate 1 from the light incident side thereof can penetrate the colored portion 22 efficiently, and the colored portion 22 has a function of preventing outside light from being reflected to the light emission side of the microlens substrate 1. By providing such a colored portion 22, it is possible to obtain a projected image having more excellent contrast in the case where the microlens substrate 1 is applied to the transmission screen 10 and/or the rear projection 300.

In this regard, the color of the colored portion 22 is not particularly limited. It is preferable that the color of the colored portion 22 is an achromatic color, particularly black as appearance using a coloring agent in which the color thereof is based on blue and red, brown or yellow is mixed therein. Further, it is preferable that light having specific wavelengths for controlling balance of light's three primary colors (RGB) of a light source is selectively absorbed in the colored portion 22 or penetrates the colored portion 22. This makes it possible to prevent the outside light from being reflected. The tone of color of the image formed from the light penetrating the microlens substrate 1 can be expressed exactly, and chromatic coordinate is widened (the width of expression of the tone of color is made to widen sufficiently), and therefore a darker black can be expressed. As a result, it is possible to improve the contrast of the image, in particular.

Next, a description will be given for a method of manufacturing a microlens substrate having the lens portion 2B provided with the colored portion 22.

The method of manufacturing the microlens substrate of the present embodiment is similar to the method of manufacturing a microlens substrate in the first embodiment except that the method further includes a process of applying a coloring liquid. In the coloring liquid applying process, a colored portion 22 is formed on the light incident surface of the lens portion 2B after the removing process ([B4] in the first embodiment described above).

In the coloring liquid applying process, a coloring liquid containing a coloring agent is applied onto the one major surface of the microlens substrate 1 on which the plurality of microlenses 21 are provided so that the one major surface (light incident surface) of the microlens substrate 1 is colored with the coloring agent. Thus, a colored portion 22 is formed on the lens portion 2B of the microlens substrate 1.

As the method of applying the coloring liquid onto the light incident surface of the microlens substrate 1, for example, various types of coating methods such as a doctor blade method, a spin coat method, a blush coat method, a spray coating, an electrostatic coating, an electrodeposition coating, roll coater and a printing, and a dipping method in which the lens portion 2 is immersed (soaked) in the process liquid, and the like may be mentioned. The dipping method (in particular, dip dying) is suitable among these methods. This makes it possible to form the colored portion 22 (in particular, the colored portion 22 having even color density) easily and surely.

Further, the coloring liquid supplying process may be carried out while the ambient pressure is heightened (with application of pressure). This makes it possible to accelerate the penetration of the coloring liquid into the inside of the base substrate 2, and as a result, it is possible to form the colored portion 22 efficiently with a short time.

Moreover, the coloring liquid applying process may be carried out repeatedly (that is, multiple times) if needed (for example, in the case of setting the concentration of the coloring agent in the colored portion 22 (or the color density of the colored portion 22) to be formed to higher (or darker)). Furthermore, the microlens substrate 1 may be subjected to heat treatment such as heating, cooling and the like, irradiation with light, pressurization or decompression of the atmosphere, or the like after applying the coloring liquid thereto if needed. This makes it possible to accelerate the fixing (stability) of the colored portion 22.

Next, the coloring liquid used at the present step will be described in detail.

The coloring agent contained in the coloring liquid may be any one such as various dyes and various pigments, but it is preferable that the coloring agent is a dye. More preferably it is a disperse dye and/or a cationic dye, and further more preferably it is a disperse dye. This makes it possible to form the colored portion 22 efficiently while preventing a harmful influence on the lens portion 2 on which the colored portion 22 is to be formed (for example, deterioration of the constituent material of the lens portion 2) from being generated sufficiently.

As described above, it should be noted that, even though the method of manufacturing a microlens substrate 1, the microlens substrate 1, the transmission screen 10 and the rear projection 300 according to the invention have been described with reference to the preferred embodiments shown in the accompanying drawings, the invention is not limited to these embodiments. For example, each element (component) constituting the microlens substrate 1, the transmission screen 10 and the rear projection 300 may be replaced with one capable of performing the same or a similar function.

Further, in the first embodiment described above, even though it has been described that the diffusing agent 25 is used as the additive, the invention is not limited thereto. For example, a coloring agent is used as the additive in the second embodiment described above, or an additive constituted from a diffusing agent and a coloring agent may be used.

Moreover, in the second embodiment described above, even though it has been described that the coloring agent 27 is used as the additive, the invention is not limited thereto. For example, a diffusing agent is used as the additive in the first embodiment described above, or an additive constituted from a diffusing agent and a coloring agent may be used.

Furthermore, in the third embodiment described above, even though it has been described that the diffusing agent 25 is used as the additive, the invention is not limited thereto. For example, a coloring agent is used as the additive in the second embodiment described above, or an additive constituted from a diffusing agent and a coloring agent may be used.

Further, a colored portion 22 as described in the third embodiment may be provided on the lens portion 2 in the first embodiment. In this case, an additive is not limited to one constituted from only the diffusing agent 25, and may be one constituted from a diffusing agent and a coloring agent.

Moreover, a colored portion 22 as described in the third embodiment may be provided on the lens portion 2A in the second embodiment. In this case, an additive is not limited to one constituted from only the coloring agent 27, and may be one constituted from a diffusing agent and a coloring agent.

Furthermore, in the third embodiment described above, even though it has been described that the colored portion 22 is provided on the whole light incident surface of the microlens substrate 1 (that is, lens portion 2), the colored portion 22 may be provided on a part of the light incident surface of the microlens substrate 1.

Further, in the first to third embodiments described above, even though it has been described that the microlenses 21 are arranged in a random manner when viewed from above the light incident surface or the light emission surface of the microlens substrate 1, the shape and arrangement of the microlenses 21 are not limited to the above. For example, the microlenses 21 may be arranged in a lattice-like pattern, or may be formed in a honeycombed pattern.

Moreover, in the first embodiment described above, even though it has been described that the transmission screen 10 is provided with the microlens substrate 1 and the Fresnel lens 5, the transmission screen 10 of the invention need not be provided with the Fresnel lens 5 necessarily. For example, the transmission screen 10 may be constructed from only the microlens substrate 1 of the invention practically.

Furthermore, in the first to third embodiments described above, even though it has been described that the microlens substrate 1 is a member constituting the transmission screen 10 or the rear projection 300, the microlens substrate 1 of the invention is not limited to one to be applied to a transmission screen 10 or a rear projection 300, and it may be applied to one for any use. For example, the microlens substrate 1 may be applied to a constituent member of a liquid crystal light valve in a projection display (front projection) or a so-called front screen.

Further, a black matrix may be provided on the light emission surface of the microlens substrate 1 as a light shielding layer as needed. By providing a black matrix on the light emission surface of the microlens substrate 1, the black matrix can absorb outside light (undesirable outside light for forming a projected image), and this makes it possible to obtain an image projected onto a screen that has further excellent contrast.

1. A method of manufacturing a microlens substrate, the microlens substrate being composed of a base substrate having two major surfaces and having light transparency and a lens portion having a plurality of microlenses, the lens portion being provided on one of the two major surfaces of the base substrate, the method comprising the steps of:
preparing a substrate with concave portions having two major surfaces, a plurality of concave portions being formed on one of the two major surfaces of the substrate with concave portions;
supplying a resin material for forming the lens portion onto the one major surface of the substrate with concave portions on which the plurality of concave portions are formed, the resin material being constituted from a photopolymer having a photocuring property as a main component and containing an additive constituted from at least one of a diffusing agent and a coloring agent, the diffusing agent having a function of diffusing incident light to the resin material;
preparing the base substrate;
mounting the base substrate on the supplied resin material;
photocuring the resin material by light to form the lens portion in a state where the base substrate is in contact with the resin material, whereby the base substrate is bonded to the photocured resin material; and
removing the substrate with concave portions from the photocured resin material to obtain the microlens substrate provided with the lens portion.

2. The method as claimed in claim 1, wherein the diffusing agent includes particles constituted from polystyrene, glass or organic cross-linking polymer.

3. The method as claimed in claim 1, wherein the coloring agent includes at least one of paints and dyes.

4. The method as claimed in claim 1, wherein an amount of the additive contained in the resin material is in the range of 0.01 to 10% by weight.

5. The method as claimed in claim 1, further comprising the step of:
prior to the resin material photocuring step, attracting the coloring agent contained in the resin material toward the bottom side of each of the concave portions of the substrate with concave portions.

6. The method as claimed in claim 5, wherein the coloring agent has a magnetic property, and wherein in the coloring agent attracting step a magnetic material is prepared and placed at the side of the substrate with concave portions on which the plurality of concave portions are not formed, whereby the coloring agent is attracted toward the bottom side of each of the concave portions so as to form a layer of the coloring agent.

7. The method as claimed in claim 1, further comprising the step of:
after the substrate removing step, applying a coloring liquid containing a coloring agent onto the one major surface of the microlens substrate on which the plurality of microlenses are provided so that the one major surface of the microlens substrate is colored with the coloring agent.

8. The method as claimed in claim 7, wherein the coloring liquid applying step is carried out by dipping.

9. The method as claimed in claim 1, wherein the substrate with concave portions is formed of a material having light transparency.

10. The method as claimed in claim 9, wherein in the resin material photocuring step the light is entered to the resin material through the substrate with concave portions.

11. The method as claimed in claim 10, wherein the light is ultraviolet rays.

12. The method as claimed in claim 6, wherein the average thickness of the layer of the coloring agent is in the range of 1 to 200 μm.

13. A microlens substrate manufactured using the method defined by claim 1.

14. A microlens substrate comprising:
a base substrate having two major surfaces and having light transparency; and
a lens portion provided with a plurality of microlenses, the lens portion being bonded onto one of the two major surfaces of the base substrate,
wherein the lens portion is formed of a resin material constituted from a photopolymer having a photocuring property as a main component, and the resin material contains an additive constituted from at least one of a diffusing agent and a coloring agent, in which the diffusing agent has a function of diffusing incident light to the resin material.

15. The microlens substrate as claimed in claim 14, wherein the lens portion is provided with a layer of the coloring agent at the side of the microlens substrate on which the plurality of microlenses are formed, and almost all the coloring agent in the lens portion is included in the layer.

16. A transmission screen comprising the microlens substrate defined by claim 14.

17. A rear projection comprising the transmission screen defined by claim 16.
